(19) United States
(12) Patent Application Publication
(10) Pub. No.: US 2020/0365320 A1
(43) Pub. Date: Nov. 19, 2020

(54) METHOD FOR MANUFACTURING COIL, COIL AND ELECTRONIC DEVICE

(71) Applicant: Goertek, Inc., Weifang City, Shandong (CN)

(72) Inventors: Quanbo Zou, Weifang City, Shandong (CN); Zhe Wang, Weifang City, Shandong (CN); Qinglin Song, Weifang City, Shandong (CN); Guanxun Qiu, Weifang City, Shandong (CN)

(73) Assignee: Goertek, Inc., Weifang City, Shandong (CN)

(21) Appl. No.: 16/643,443

(22) PCT Filed: Sep. 5, 2017
(86) PCT No.: PCT/CN2017/100548

§ 371 Date: Feb. 28, 2020

(30) Foreign Application Priority Data
Aug. 30, 2017 (CN) 201710764004.0

(51) Int. Cl. H01F 41/04

(52) U.S. Cl. CPC H01F 41/043; H01F 41/042

(57) ABSTRACT

Disclosed are a method for manufacturing a coil, a coil, and an electronic device. The method includes: firstly forming a metal seed layer on a polymer protective layer; forming a mask on a surface of the metal seed layer; forming a coiled metal coating on the exposed metal seed layer; removing the mask and the metal seed layer in the coiled metal coating to obtain a metal coil; forming an encapsulation layer on the metal coil to encapsulate the metal coil; and attaching the encapsulation layer to an adhesive tape, and transmitting laser through a laser-transmitting substrate to act on the polymer protective layer, such that the laser-transmitting substrate is detached.

### CROSS-REFERENCE TO RELATED APPLICATIONS

This application is a National Stage of International Application No. PCT/CN2017/100548 filed on Sep. 5, 2017, which is hereby incorporated by reference in its entirety.

### TECHNICAL FIELD

The present invention relates to the field of processing and manufacturing of components, and more particularly, to a method for manufacturing a coil. The present invention further relates to a coil manufactured by the method and an electronic device employing the coil.

### BACKGROUND

As a common component in modern electronic products, a coil may be applied to sound production apparatuses such as a speaker and a receiver, and it may also be applied to a motor, an inductor, a transformer and a loop antenna, as well as the wireless charging field of a smart phone, a smart watch or other wearable electronic devices.

With the development of science and technology, a traditional coil cannot meet the demand for light weight and compactness of the modern electronic products due to its big size, high internal resistance and large weight. Moreover, because of the coil's requirements for working parameters and its relatively special structure, it is difficult to manufacture a high-performance miniaturized coil on a plane substrate by the conventional microelectronic technology.

### SUMMARY

An objective of the present invention is to provide a new technical solution of a method for manufacturing a coil.

In one aspect of the present invention, there is provided a method for manufacturing a coil, including:

(a) forming a polymer protective layer on a laser-transmitting substrate and forming a metal seed layer on the polymer protective layer;

(b) forming a mask on a surface of the metal seed layer, performing coil-like patterning on the mask, and exposing the metal seed layer under the pattern;

(c) performing electroplating or chemical plating to form a coiled metal coating on the exposed metal seed layer;

(d) removing the mask and the metal seed layer in the coiled metal coating to obtain a metal coil;

(e) forming an encapsulation layer on the metal coil to encapsulate the metal coil; and

(f) attaching the encapsulation layer to an adhesive tape, and transmitting laser through the laser-transmitting substrate to act on the polymer protective layer, such that the laser-transmitting substrate is detached.

Optionally, the polymer protective layer is formed on the laser-transmitting substrate by means of spin coating, spray coating or laminating, and the metal seed layer is formed on the polymer protective layer after the polymer protective layer is cured.

Optionally, the polymer protective layer is made from polyimide, benzocyclobutene, polybenzoxazole, epoxy resin, silica gel, parylene, polyamide or polyurethane.

Optionally, in the step (a), the metal seed layer is formed on the polymer protective layer by means of physical vapor deposition (PVD).

Optionally, the metal seed layer has a thickness of 0.05 μm to 5 μm.

Optionally, in the step (c), the metal coating has a thickness of 5 μm to 200 μm.

Optionally, the mask is made from a photoresist.

Optionally, in the step (e), the encapsulation layer is made from polyimide, benzocyclobutene, polybenzoxazole, epoxy resin, silica gel, parylene, polyamide or polyurethane, and is formed on the metal coil by means of spin coating, spray coating or laminating.

Optionally, the top of the encapsulation layer is 1 μm to 25 μm higher than that of the metal coil.

Optionally, an external pad of the metal coil is formed on the polymer protective layer by the steps (b) to (d).

In another aspect of the present invention, there is provided a coil manufactured by the foregoing method.

In yet another aspect of the present invention, there is provided an electronic device including the abovementioned coil.

Compared with the prior art, the method provided by the present invention can produce a miniaturized coil by pre-depositing the metal seed layer and then forming the metal coating on the metal seed layer, without causing cracking or detachment of the coil. In the method provided by the present invention, each process step is a mature manufacturing procedure, and is applicable to batch production, with controllable cost. By controlling each manufacturing procedure, pitches and dimensions of the coil can be reasonably selected to guarantee the performance of the coil when used at medium and high frequencies.

Other features and advantages of the present invention will become apparent from the following detailed description of exemplary embodiments of the present invention with reference to the accompanying drawings.

### BRIEF DESCRIPTION OF THE DRAWINGS

The accompanying drawings incorporated in the description and forming a part thereof illustrate the embodiments of the present invention and are used to explain the principle of the present invention along therewith.

FIGS. 1 to 8 are process flow diagrams of a method for manufacturing a coil according to the present invention.

### DETAILED DESCRIPTION

Various exemplary embodiments of the present invention will now be described in detail with reference to the accompanying drawings. It should be noted that the relative arrangement, numerical expressions and numerical values of the components and steps set forth in these embodiments do not limit the scope of the present invention unless otherwise specified.

The following description of at least one exemplary embodiment is in fact merely illustrative and is in no way intended as a limitation to the present invention and its application or use.

Techniques, methods, and devices known to those of ordinary skill in the relevant art may not be discussed in detail but where appropriate, the techniques, methods, and devices should be considered as part of the description.

Among all the examples shown and discussed herein, any specific value should be construed as merely illustrative and not as a limitation. Thus, other examples of exemplary embodiments may have different values.

It should be noted that similar reference numerals and letters denote similar items in the accompanying drawings, and therefore, once an item is defined in a drawing, there is no need for further discussion in the accompanying drawings.

The present invention provides a method for manufacturing a coil and a coil manufactured by the method. By this method, the size of the coil may be very small. The method is low in cost, and each process step is a mature manufacturing procedure, and is suitable for batch production.

The coil manufactured by the method is controllable in coil pitch, low in internal resistance, small in thermal loss and excellent in electric and thermal conductivity. The coil can be applied to various electronic devices, such as low-power, medium power and even high-power wireless charging fields, and the charging field of a smart phone, a smart watch or other wearable electronic devices.

FIGS. 1 to 8 are process flow diagrams of a method for manufacturing a coil according to the present invention. In particular, the method includes the following steps.

(a) A polymer protective layer 2 is formed on a laser-transmitting substrate 1 first, and then, a metal seed layer 3 is formed on the polymer protective layer 2.

Referring to FIG. 1, the substrate is made of a laser-transmitting material, e.g., glass, sapphire or other laser-transmitting materials well known to those skilled in the art, such that degumming or stripping can be performed subsequently by means of laser. The polymer protective layer 2 may provide a stable base for subsequent metal deposition, photoetching and electroplating.

The polymer protective layer 2 may be made from a polymer material resistant to high temperature, such as polyimide, benzocyclobutene, polybenzoxazole, epoxy resin, silica gel, parylene, polyamide or polyurethane. In its forming process, the polymer protective layer may be formed on the laser-transmitting substrate 1 by spin coating, spray coating, laminating or other means well known to those skilled in the art.

Preferably, the polymer protective layer 2 is formed on the laser-transmitting substrate 1, and the metal seed layer 3 is formed on a surface of the polymer protective layer 2 after the polymer protective layer 2 is cured, such that the metal seed layer 3 may not be bonded inside the polymer protective layer 2.

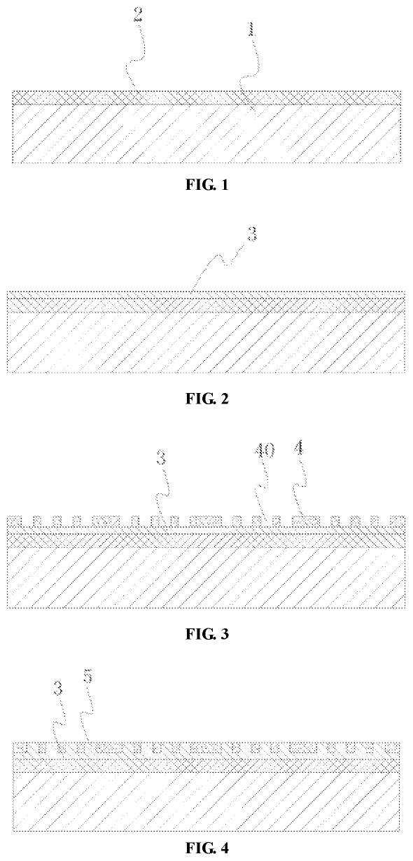

The metal seed layer 3 is preferably made of copper owing to its favorable electric and thermal conductivity and relatively low cost. Referring to FIG. 2, the metal seed layer 3 may be formed on the cured polymer protective layer 2 by means of PVD, such as vacuum evaporation, sputter coating, arc plasma plating, ion plating, or molecular beam epitaxy. All of these processes are common sense to those skilled in the art, and will not be further described in detail herein.

The relatively thin metal seed layer 3 may be formed on the polymer protective layer 2 by means of PVD. For example, in a specific embodiment of the present invention, the metal seed layer 3 may have a thickness of 0.05 μm to 5 μm. It should be noted herein that the metal seed layer 3 will crack or be stripped if the metal seed layer 3 deposited in this step is excessively thick, and the excessively thick metal seed layer is high in cost and unsuitable for batch production.

(b) A mask 4 is formed on a surface of the metal seed layer 3, coil-like patterning is performed on the mask 4, and the metal seed layer 3 under patterns is exposed.

Referring to FIG. 3, the mask may be made from a photoresist, and certainly, it may also be made from other materials well known to those skilled in the art, which will not be described in detail herein.

In particular, patterning is performed on the mask 4 according to actual demands after the mask 4 is formed on the surface of the metal seed layer 3. In this embodiment, the coiled patterns 40 are formed on the mask 4, and the metal seed layer 3 under the patterns 40 is exposed.

It should be noted herein that for the purpose of batch production, a plurality of coiled patterns 40 may be formed on the mask 4, such that a plurality of metal coils is simultaneously formed on the metal seed layer 3 in a subsequent process, and its specific number is determined based on dimensions of the laser-transmitting substrate 1 and the metal coil. For example, in a specific embodiment of the present invention, an 8-inch laser-transmitting substrate 1 is adopted, the subsequently formed coil having an external diameter of 48 mm, and at this time, at most 10 coils may be simultaneously formed on the laser-transmitting substrate 1 of this size.

(c) Electroplating or chemical plating is performed to form a coiled metal coating 5 on the exposed metal seed layer 3.

Referring to FIG. 4, as the metal seed layer 3 is formed on the substrate, the relatively thick metal coating 5 may be formed in an area of the metal seed layer 3 via electroplating or chemical plating. The metal coating 5 may be made from the same material as the metal seed layer 3, for example, copper, and may have a thickness of 5 μm to 200 μm, a line width of 80 μm and a line pitch of 20 μm.

(d) The mask 4 and the metal seed layer 3 in the coiled metal coating 5 are removed to obtain a metal coil 6.

Referring to FIG. 5, since the metal seed layer 3 that covers the polymer protective layer 2 is applied integrally, it is necessary to remove the mask 4 and the metal seed layer 3 in the coiled metal coating 5 to form the circles of metal coil 6. It may also be appreciated that the metal seed layer 3 located right below the metal coating 5 is retained while the metal seed layer 3 located right below the mask 4 is removed.

In particular, for example, the mask 4 which is made from a photoresist can be removed by means of wet etching with acetone or a corrosive liquid well known to those skilled in the art. The metal seed layer 3 made of copper can be removed by a copper corrosion liquid, e.g., glacial acetic acid and hydrogen peroxide. These are all common sense for those skilled in the art and will not be described in detail herein.

(e) An encapsulation layer 8 is formed on the metal coil 6 to encapsulate the metal coil 6.

Referring to FIG. 6, the encapsulation layer 8 and the polymer protective layer 2 may be made from the same or different materials. For example, the encapsulation layer 8 may be made from polyimide, benzocyclobutene, polybenzoxazole, epoxy resin, silica gel, parylene, polyamide or polyurethane. In its forming process, the encapsulation layer may be formed on the metal coil 6 by spin coating, spray coating, laminating or other means well known to those skilled in the art to encapsulate the metal coil 6.

In a specific embodiment of the present invention, the top of the encapsulation layer 8 is 1 μm to 25 nm higher than that of the metal coil 6.

(f) The encapsulation layer 8 is bonded to an adhesive tape 9, and then, laser is transmitted through the laser-transmitting substrate 1 and acts on the polymer protective layer 2, such that the laser-transmitting substrate 1 is detached.

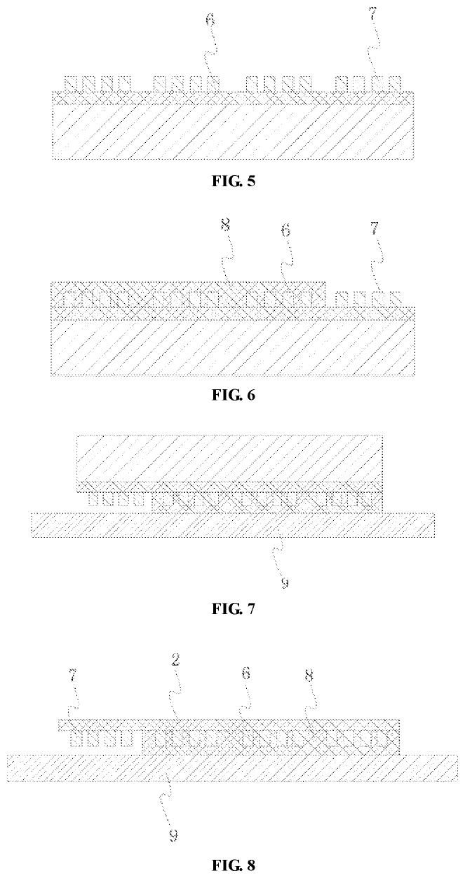

Referring to FIG. 7, the laser is transmitted through the laser-transmitting substrate 1 and acts on the polymer protective layer 2 after the encapsulation layer 8 is bonded to the adhesive tape 9, such that the laser-transmitting substrate 1 loses adhesion to the polymer protective layer 2 and is detached therefrom. Thus, degumming or stripping is performed by means of laser.

A final metal coil encapsulation structure is bonded to the adhesive tape 9. When necessary, an adhesive surface of the adhesive tape 9 may lose its adhesiveness (or the adhesiveness becomes very low) after being exposed to UV, such that the metal coil encapsulation structure can be easily picked up from the adhesive tape 9, and for example, it can be picked up by a vacuum nozzle and conveyed to an assembly station.

Compared with the prior art, the method provided by the present invention can produce a miniaturized coil by pre-depositing the metal seed layer and then forming the metal coating on the metal seed layer, without causing cracking or detachment of the coil. In the method provided by the present invention, each process step is a mature manufacturing procedure, and is suitable for batch production, and the cost thereof is controllable. By controlling each manufacturing procedure, pitches and dimensions of the coil can be reasonably selected to guarantee the performance of the coil used with medium and high frequencies.

In a preferred embodiment of the present invention, an external pad 7 of the metal coil 6 may be further formed on the polymer protective layer 2 by the steps (b) to (d). For example, in step (b), it is necessary to form an outline of the external pad 7 on the mask 4 when patterning is performed on the mask 4; in step (c), the outline of the external pad is formed on the exposed metal seed layer 3 in an area of the external pad when the metal coating 5 is formed by means of electroplating or chemical plating; and in step (d), the mask 4 and the metal seed layer 3 in corresponding positions are removed to finally form the external pad 7 for connection to an external circuit.

It should be noted herein that since the external pad 7 is configured for use in welding of the external circuit, the external pad 7 needs to be exposed in the encapsulation process of step (e). (See FIG. 6)

While certain specific embodiments of the present invention have been illustrated by way of example, it will be understood by those skilled in the art that the foregoing examples are provided for the purpose of illustration and are not intended to limit the scope of the present invention. It will be understood by those skilled in the art that the foregoing embodiments may be modified without departing from the scope and spirit of the invention. The scope of the present invention is subject to the attached claims.

1. A method for manufacturing a coil, comprising:
(a) forming a polymer protective layer on a laser-transmitting substrate and forming a metal seed layer on the polymer protective layer;
(b) forming a mask on a surface of the metal seed layer, performing coil-like patterning on the mask, and exposing the metal seed layer under the pattern;
(c) performing one or more of electroplating and chemical plating to form a coiled metal coating on the exposed metal seed layer;
(d) removing the mask and the metal seed layer in the coiled metal coating to obtain a metal coil;
(e) forming an encapsulation layer on the metal coil to encapsulate the metal coil; and
(f) attaching the encapsulation layer to an adhesive tape, and transmitting a laser transmission through the laser-transmitting substrate to act on the polymer protective layer, such that the laser-transmitting substrate is detached.

2. The method of claim 1, wherein the polymer protective layer is formed on the laser-transmitting substrate by one or more of spin coating, spray coating and laminating, and the metal seed layer is formed on the polymer protective layer after the polymer protective layer is cured.

3. The method of claim 1, wherein the polymer protective layer is made from polyimide, benzocyclobutene, polybenzoxazole, epoxy resin, silica gel, parylene, polyamide or polyurethane.

4. The method of claim 1, wherein the forming a metal seed layer on the polymer protective layer comprises using the metal seed layer physical vapor deposition (PVD).

5. The method of claim 1, wherein the metal seed layer has a thickness of 0.05 μm to 5 μm.

6. The method of claim 1, wherein the metal coating has a thickness of 5 μm to 200 μm.

7. The method of claim 1, wherein the mask is made from a photoresist.

8. The method of claim 1, wherein the encapsulation layer is made from one or more of polyimide, benzocyclobutene, polybenzoxazole, epoxy resin, silica gel, parylene, polyamide and polyurethane, and is formed on the metal coil by one or more of spin coating, spray coating and laminating.

9. The method of claim 1, wherein the top of the encapsulation layer is 1 μm to 25 μm higher than that of the metal coil.

10. The method of claim 1, wherein an external pad of the metal coil is formed on the polymer protective layer.

11. A coil manufactured by the method of claim 1.

12. An electronic device comprising the coil of claim 11.
